(19) United States
(12) Patent Application Publication
(10) Pub. No.: US 2008/0319756 A1
(43) Pub. Date: Dec. 25, 2008

(54) Electronic Device and Method for Determining a Mixing Parameter

(75) Inventors: Aweke Nagash Lemma, Eindhoven (NL); Francesco Felix Maria Zijderveld, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics, N.V., Eindhoven (NL)

(21) Appl. No.: 12/097,535

(22) PCT Filed: Dec. 14, 2006
(86) PCT No.: PCT/IB06/54844

§ 371 Date: Jun. 14, 2008

(30) Foreign Application Priority Data
Dec. 22, 2005 (EP) 05112764.5

(51) Int. Cl. G10L 21/00

(52) U.S. Cl. 704/270

(57) ABSTRACT

The method of determining a parameter for mixing a first content item (X₁) and a second content item (X₂) comprises the steps of detecting a simultaneous (59) occurrence of vocals (55, 57) at a potential mixing point between the first content item (X₁) and the second content item (X₂), and determining (61, 63) a mixing parameter in dependence on the detected simultaneous occurrence of vocals at the potential mixing point. The method of mixing a first content item (X₁) and a second content item (X₂) comprises the steps of retrieving a mixing point between the first content item (X₁) and the second content item (X₂) from a database, and mixing (65) the first content item (X₁) and the second content item (X₂) at the mixing point. The electronic device and computer program of the invention are operative to perform one or both of the methods.

The invention relates to an electronic device for determining a parameter for mixing a first content item and a second content item.

The invention further relates to a method of determining a parameter for mixing a first content item and a second content item.

The invention also relates to a database comprising mixing parameters.

The invention further relates to an electronic device for mixing a first content item and a second content item.

The invention also relates to a method of mixing a first content item and a second content item.

The invention further relates to a computer program for making a programmable device operative to perform a method of determining a parameter for mixing a first content item and a second content item and/or a method of mixing a first content item and a second content item.

Examples of such methods are known from US2003/183064 A1. US2003/183064 A1 discloses a sequential playback system, also referred to as automatic music mixing system, which is configured to select each sequential song based upon characteristics of an ending segment of each preceding song. Transition pieces are optionally provided to facilitate a smooth transition between songs. The transition piece may be created by decreasing the volume/loudness at the end of each song (fading out) and then increasing the volume/loudness at the start of the next song (fading in). Alternatively, an ending segment of a song and a beginning segment of the next song can be extracted, and the transition piece may be created by blending particular characteristics of the extracted segments. The known automatic music mixing system has the drawback that when it creates mixes in which sequential songs are played back simultaneously for more than just a short moment, these are not always pleasant for a user to hear.

It is a first object of the invention to provide an electronic device for determining a parameter for mixing a first content item and a second content item, which is capable of determining the mixing parameter in such a way that mixes can be created which are less often unpleasant for a user to hear.

It is a second object of the invention to provide a method of determining a parameter for mixing a first content item and a second content item, which determines the mixing parameter in such a way that mixes can be created which are less often unpleasant for a user to hear.

It is a third object of the invention to provide an electronic device for mixing a first content item and a second content item, which is capable of creating mixes which are less often unpleasant for a user to hear.

It is a fourth object of the invention to provide a method of mixing a first content item and a second content item, which creates mixes which are less often unpleasant for a user to hear.

According to the invention, the first object is realized in that the electronic device comprises detection means for detecting a simultaneous occurrence of vocals at a potential mixing point between the first content item and the second content item, the potential mixing point comprising a first position in the first content item and a second position in the second content item, and determining means for determining said parameter in dependence on the detected simultaneous occurrence of vocals at the potential mixing point.

Vocal clashes have been found to create artifacts that significantly affect the quality of the mix, particularly when the mixing/transition interval is relatively large. Audio classification/segmentation techniques are used to determine if potential vocal clashes occur and to appropriately control the transition so that such clashes are minimized. A potential mixing point can be found, for example, by looking for aligned accented beats in the outro of the first content item and the intro of the second content item.

In an embodiment of the electronic device, the determining means is operative to select a transition profile in dependence on the detected simultaneous occurrence of vocals at the potential mixing point, and determine said parameter from the selected transition profile and the potential mixing point. The transition profile may comprise, for example, whether a short fade in/out or a normal fade/in out should be used.

The determining means may be operative to select one of the potential mixing points and a further mixing point in dependence on the detected simultaneous occurrence of vocals at the potential mixing point and determine said parameter from the selected mixing point. If several potential mixing points are present, the one without a vocal clash is preferably used. If there is no potential mixing point without a vocal clash, a suitable transition profile (e.g. a short fade in/out) is preferably selected.

According to the invention, the second object is realized in that the method comprises the steps of detecting a simultaneous occurrence of vocals at a potential mixing point between the first content item and the second content item, the potential mixing point comprising a first position in the first content item and a second position in the second content item, and determining said parameter in dependence on the detected simultaneous occurrence of vocals at the potential mixing point. The method may be performed, for example, by a computer program or by a service provider (e.g. providing a database of mixing points).

In an embodiment of the method, the determining step comprises selecting a transition profile in dependence on the detected simultaneous occurrence of vocals at the potential mixing point, and determining said parameter from the selected transition profile and the potential mixing point.

The determining step may comprise selecting one of the potential mixing points and a further mixing point in dependence on the detected simultaneous occurrence of vocals at the potential mixing point, and determining said parameter from the selected mixing point.

In a further aspect of the invention, a database comprises a plurality of associations, each of the plurality of associations comprising a mixing point between a first content item and a second content item, the mixing point comprising a first position in the first content item and a second position in the second content item. To avoid the processing complexity of determining the mixing points in real-time, the mixing points between content items can be stored in a database. The content items themselves may also be part of the database.

In an embodiment of the database, the mixing point has been selected by means of a method comprising the steps of detecting a simultaneous occurrence of vocals at a potential mixing point, and selecting one of the potential mixing points and a further mixing point in dependence on the detected simultaneous occurrence of vocals at the potential mixing point.

At least a plurality of the associations may further comprise a transition profile associated with the mixing point.

The transition profile may have been selected by means of a method comprising the steps of detecting a simultaneous occurrence of vocals at the mixing point, and selecting the transition profile in dependence on the detected simultaneous occurrence of vocals at the mixing point.

According to the invention, the third object is realized in that the electronic device comprises retrieval means for retrieving a mixing point between the first content item and the second content item from a database, the mixing point comprising a first position in the first content item and a second position in the second content item, and mixing means for mixing the first content item and the second content item at the mixing point. The electronic device may be, for example, a resource-constrained device such as a mobile music player or television connected to a network.

In an embodiment of the electronic device, the mixing point has been selected by means of a method comprising the steps of detecting a simultaneous occurrence of vocals at a potential mixing point, and selecting one of the potential mixing points and a further mixing point in dependence on the detected simultaneous occurrence of vocals at the potential mixing point.

The retrieval means may further be operative to retrieve a transition profile associated with the mixing point.

The retrieval means may be operative to retrieve a plurality of mixing points, each mixing point being between the first content item and one of a plurality of further content items, and select one of the plurality of further content items as the second content item. Not all content items that are available in a collection of content items can be mixed with the desired quality (e.g. with a normal fade in/out without artifacts). If a first content item can be mixed with a second content item with the desired quality at a certain mixing point, said certain mixing point and a reference to the two content items can be stored in the database. When a second (subsequent) content item needs to be selected, the selection of the second content item is limited to only those content items from the collection that can be mixed with the first content item with the desired quality.

The retrieval means may be operative to select one of the plurality of further content items as the second content item in dependence on a similarity between a current position in the first content item and a first position in each mixing point. Thus, the selection of the second content item may further be limited to only those further content items that can be mixed at or near the current position of the first content item. Although it is more difficult to find suitable mixing points in the ‘meat’ of a song, this embodiment is useful when a user presses a ‘skip song’ button.

According to the invention, the fourth object is realized in that the method comprises the steps of retrieving a mixing point between the first content item and the second content item from a database, the mixing point comprising a first position in the first content item and a second position in the second content item, and mixing the first content item and the second content item at the mixing point.

In an embodiment of the method, the mixing point has been selected by means of a method comprising the steps of detecting a simultaneous occurrence of vocals at a potential mixing point, and selecting one of the potential mixing points and a further mixing point in dependence on the detected simultaneous occurrence of vocals at the potential mixing point.

The method may further comprise the step of retrieving a transition profile associated with the mixing point.

The step of retrieving a mixing point may comprise a step of retrieving a plurality of mixing points, each mixing point being between the first content item and one of a plurality of further content items, and a step of selecting one of the plurality of further content items as the second content item.

The selecting step may comprise selecting one of the plurality of further content items as the second content item in dependence on a similarity between a current position in the first content item and a first position in each mixing point.

These and other aspects of the invention are apparent from and will be further elucidated, by way of example, with reference to the drawings, in which:

FIG. 1 is a flow diagram of the method of determining a mixing parameter;

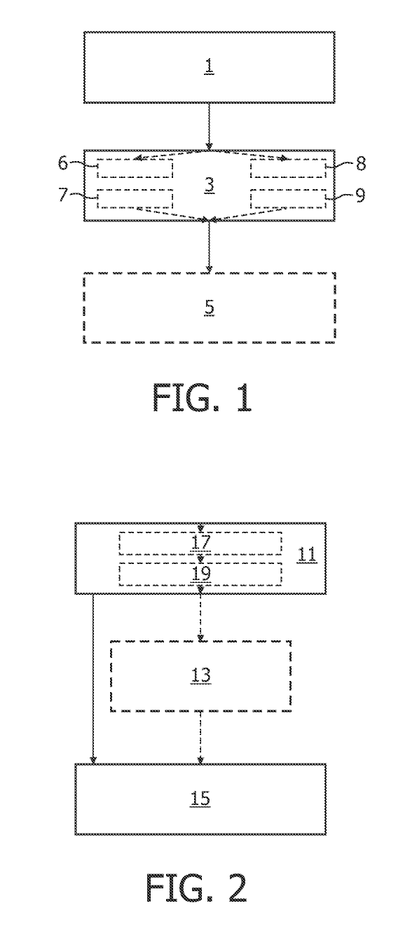

FIG. 2 is a flow diagram of the mixing method;

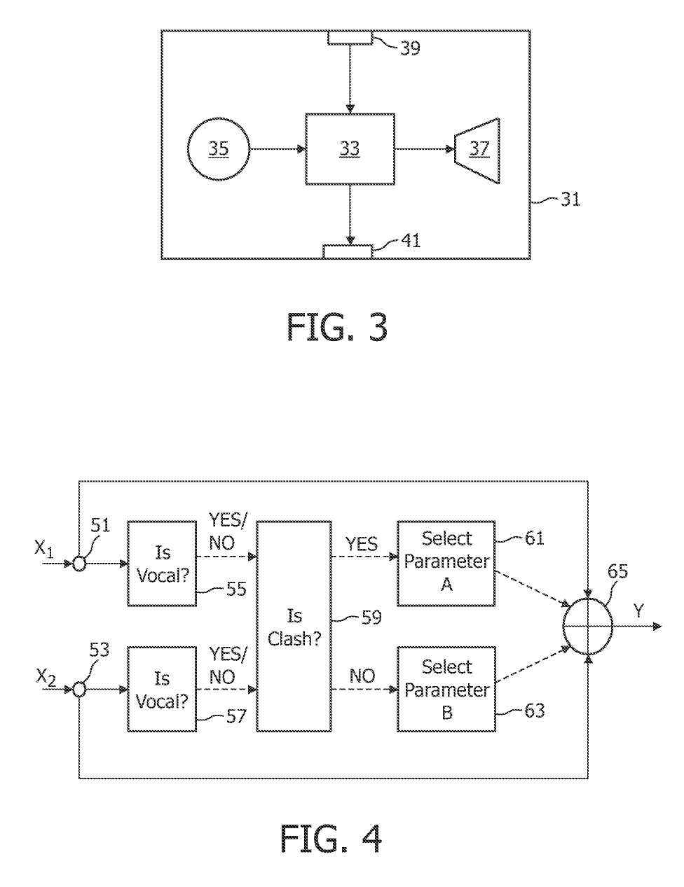

FIG. 3 is a block diagram of an electronic device for performing a method of the invention; and

FIG. 4 is a flow diagram of an embodiment of the method of determining a mixing parameter.

Corresponding elements in the drawings are denoted by the same reference numerals.

The method of determining a parameter for mixing a first content item and a second content item comprises at least two steps, see FIG. 1. A step 1 comprises detecting a simultaneous occurrence of vocals at a potential mixing point between the first content item and the second content item. The potential mixing point comprises a first position in the first content item and a second position in the second content item. A step 3 comprises determining said parameter in dependence on the detected simultaneous occurrence of vocals at the potential mixing point. A simultaneous occurrence of vocals can be detected, for example, by using the method suggested by Tin Lay Nwe and Ye Wang in ‘Automatic detection of vocal segments in popular songs’ (ISMIR 2004 Conference Proceedings, 10-14 Oct. 2004, Barcelona, Spain).

Step 3 may comprise a step 6 of selecting a transition profile in dependence on the detected simultaneous occurrence of vocals at the potential mixing point, and a step 7 of determining said parameter from the selected transition profile and the potential mixing point.

Alternatively or additionally, step 3 may comprise a step 8 of selecting one of the potential mixing points and a further mixing point in dependence on the detected simultaneous occurrence of vocals at the potential mixing point, and a step 9 of determining said parameter from the selected mixing point.

The method of FIG. 1 may further comprise a step 5 of mixing the first content item and the second content item, using the determined parameter.

The method of mixing a first content item and a second content item comprises at least two steps, see FIG. 2. A step 11 comprises retrieving a mixing point between the first content item and the second content item from a database. The mixing point comprises a first position in the first content item and a second position in the second content item. A step 15 comprises mixing the first content item and the second content item at the mixing point.

The mixing method may further comprise a step 13 of retrieving a transition profile associated with the mixing point.

Step 11 may comprise a step 17 of retrieving a plurality of mixing points, each mixing point being between the first content item and one of a plurality of further content items, and a step 19 of selecting one of the plurality of further content items as the second content item.

Step 19 may comprise selecting one of the plurality of further content items as the second content item in dependence on a similarity between a current position in the first content item and a first position in each mixing point.

FIG. 3 shows an electronic device 31 for performing the methods of the invention. In this embodiment, the electronic device 31 comprises electronic circuitry 33, a storage means 35, a reproduction means 37, an input 39 and an output 41. The electronic device 31 may be, for example, a PC or other stationary audio and/or video player, or a portable audio and/or video player. The electronic device 31 may be a local or remote (e.g. for selling music) music server. The electronic circuitry 33 may be a general-purpose or an application-specific processor. The electronic circuitry 33 may be capable of executing a computer program. The electronic circuitry may comprise, in software and/or in hardware, the detection means, the determining means, the retrieval means and/or the mixing means.

The storage means 35 may comprise, for example, a hard disk, a solid-state memory, an optical disc reader or a holographic storage means. The storage means 35 may comprise a database, the database comprising a plurality of associations, each of the plurality of associations comprising a mixing point between a first content item and a second content item, the mixing point comprising a first position in the first content item and a second position in the second content item. Alternatively, this database could be stored externally to the electronic device, e.g. on a (different) server. The reproduction means 37 may comprise, for example, a loudspeaker.

The input 39 and output 41 may comprise, for example, a network connector, e.g. a USB connecter or an Ethernet connector, an analog audio and/or video connector, such as a cinch connector or a SCART connector, or a digital audio and/or video connector, such as a HDMI or SPDIF connector. The input 39 and output 41 may comprise a wireless receiver and/or transmitter. The storage means 35, the reproduction means 37, the input 39 and/or the output 41 are provided in dependence on the desired functionality.

FIG. 4 shows an embodiment of the method of determining a parameter for mixing a first content item X₁ and a second content item X₂ (e.g. two songs or music video clips). Content item X₁ is split into a signal for mixer 65 and a signal for vocal detector 55 in splitter 51. Content item X₂ is split into a signal for mixer 65 and a signal for vocal detector 57 in splitter 53. The existence of vocal components at a potential mixing point in the content items X₁ and X₂ is determined in vocal detectors 55 and 57. The occurrence of a vocal clash is determined in clash detector 59. A vocal clash is said to have taken place if vocals have been detected in both vocal detectors. If a vocal clash has occurred, a mixing parameter A is selected in selector 61. If no vocal clash has occurred, a mixing parameter B is selected in selector 63. The selected parameter is used in mixer 65 to mix content items X₁ and X₂. Mixing parameter A may be, for example, a transition profile which consists of a short fade in/out. Mixing parameter B may be, for example, a transition profile which consists of a normal fade in/out. As another example, selector 61 may select the potential mixing point as mixing parameter, and selector 63 may select a further mixing point as mixing parameter. In the latter case, selector 63 may simply indicate that a further mixing point should be looked for (if the mixing is performed on stored content) or waited for (if the mixing is performed in real-time). Both approaches may be combined, i.e. a short fade in/out can be selected if no further mixing point without a vocal clash is found. A normal fade in/out can be selected otherwise. Instead of or in addition to fading in and out, other ways of mixing can be used, e.g. beat-mixing.

While the invention has been described in connection with preferred embodiments, it will be understood that modifications thereof within the principles outlined above will be evident to those skilled in the art, and thus the invention is not limited to the preferred embodiments but is intended to encompass such modifications. The invention resides in each and every novel characteristic feature and each and every combination of characteristic features. Reference numerals in the claims do not limit their protective scope. Use of the verb “comprise” and its conjugations does not exclude the presence of elements or steps other than those stated in the claims. Use of the article “a” or “an” preceding an element or step does not exclude the presence of a plurality of such elements or steps.

‘Means’, as will be apparent to a person skilled in the art, are meant to include any hardware (such as separate or integrated circuits or electronic elements) or software (such as programs or parts of programs) which perform in operation or are designed to perform a specified function, be it solely or in conjunction with other functions, be it in isolation or in co-operation with other elements. The invention can be implemented by means of hardware comprising several distinct elements, and by means of a suitably programmed computer. In the device claims enumerating several means, several of these means can be embodied by one and the same item of hardware. ‘Computer program’ is to be understood to mean any software product stored on a computer-readable medium, such as a floppy disk, downloadable via a network, such as the Internet, or marketable in any other manner.

1. An electronic device (31) for determining a parameter for mixing a first content item and a second content item, the electronic device comprising:
detection means for detecting (1) a simultaneous occurrence of vocals at a potential mixing point between the first content item and the second content item, the potential mixing point comprising a first position in the first content item and a second position in the second content item; and
determining means for determining (3) said parameter in dependence on the detected simultaneous occurrence of vocals at the potential mixing point.

2. An electronic device as claimed in claim 1, wherein the determining means is operative to:
select (6) a transition profile in dependence on the detected simultaneous occurrence of vocals at the potential mixing point; and
determine (7) said parameter from the selected transition profile and the potential mixing point.

3. An electronic device as claimed in claim 1, wherein the determining means is operative to:
select (8) one of the potential mixing points and a further mixing point in dependence on the detected simultaneous occurrence of vocals at the potential mixing point; and
determine (9) said parameter from the selected mixing point.

4. A method of determining a parameter for mixing a first content item and a second content item, the method comprising the steps of:
detecting (1) a simultaneous occurrence of vocals at a potential mixing point between the first content item and the second content item, the potential mixing point comprising a first position in the first content item and a second position in the second content item; and
determining (3) said parameter in dependence on the detected simultaneous occurrence of vocals at the potential mixing point.

5. A database, comprising a plurality of associations, each of the plurality of associations comprising a mixing point between a first content item and a second content item, the mixing point comprising a first position in the first content item and a second position in the second content item.

6. A database as claimed in claim 5, wherein the mixing point has been selected by means of a method comprising the steps of:
detecting a simultaneous occurrence of vocals at a potential mixing point; and
selecting one of the potential mixing points and a further mixing point in dependence on the detected simultaneous occurrence of vocals at the potential mixing point.

7. A database as claimed in claim 5, wherein at least a plurality of the associations further comprises a transition profile associated with the mixing point.

8. A database as claimed in claim 7, wherein the transition profile has been selected by means of a method comprising the steps of:
detecting a simultaneous occurrence of vocals at the mixing point; and
selecting the transition profile in dependence on the detected simultaneous occurrence of vocals at the mixing point.

9. An electronic device (31) for mixing a first content item and a second content item, the electronic device comprising:
retrieval means for retrieving (11) a mixing point between the first content item and the second content item from a database, the mixing point comprising a first position in the first content item and a second position in the second content item; and
mixing means for mixing (15) the first content item and the second content item at the mixing point.

10. An electronic device as claimed in claim 9, wherein the mixing point has been selected by means of a method comprising the steps of:
detecting a simultaneous occurrence of vocals at a potential mixing point; and
selecting one of the potential mixing points and a further mixing point in dependence on the detected simultaneous occurrence of vocals at the potential mixing point.

11. An electronic device as claimed in claim 9, wherein the retrieval means is further operative to retrieve (13) a transition profile associated with the mixing point.

12. An electronic device as claimed in claim 9, wherein the retrieval means is operative to:
retrieve (17) a plurality of mixing points, each mixing point being between the first content item and one of a plurality of further content items; and
select (19) one of the plurality of further content items as the second content item.

13. An electronic device as claimed in claim 12, wherein the retrieval means is operative to select one of the plurality of further content items as the second content item in dependence on a similarity between a current position in the first content item and a first position in each mixing point.

14. A method of mixing a first content item and a second content item, the method comprising the steps of:
retrieving (11) a mixing point between the first content item and the second content item from a database, the mixing point comprising a first position in the first content item and a second position in the second content item; and
mixing (15) the first content item and the second content item at the mixing point.

15. A computer program for making a programmable device operative to perform the method of claim 14.
